(19) United States
(12) Patent Application Publication
(10) Pub. No.: US 2006/0063530 A1
(43) Pub. Date: Mar. 23, 2006

(54) Method for cell locking in a wireless communication device

(75) Inventor: Yongwei Niu, Shanghai (CN)

Correspondence Address: PERKINS COIE LLP;PATENT-SEA, P.O. BOX 1247, SEATTLE, WA, 98111-1247, US

(73) Assignee: Spreadtrum Communications Corporation, Sunnyvale, CA (US)

(21) Appl. No.: 11/205,359

(22) Filed: Aug. 16, 2005

(30) Foreign Application Priority Data
Sep. 8, 2004 (CN) 200410054383.7

(51) Int. Cl. H04Q 7/20

(52) U.S. Cl. 455/436; 455/525

(57) ABSTRACT

A method is provided for fixing the use of a wireless communication device in certain cell areas. The method comprises: determining the predetermined number of strongest cells and checking each of the cells in descending order of received signal level to determine whether this cell belongs to one of the operator-permitted cells. If not, the signal strength of this cell is set to zero. The checking process continues until an operator-permitted cell is found, at which point the wireless terminal marks this cell as the serving cell. If after the completion of the checking of all of the cells without finding a suitable cell, the wireless terminal enters a limited service state.

### CROSS-REFERENCE TO RELATED APPLICATION

This application claims priority to Chinese Patent Application No. 200410054383.7 filed Sep. 8, 2004, which is hereby incorporated by reference in its entirety.

### FIELD OF THE INVENTION

The present invention relates to a cell locking method in a wireless communication device, and more particularly, to a method that ensures that a wireless terminal will either camp (lock) onto an operator-specified cell or enter into a no service state.

### BACKGROUND

For normal wireless network service, the wireless terminal (the handset) has to camp on a suitable cell, tune to that cell's broadcast signal, and possibly register within the PLMN (public land mobile network) so that the wireless terminal can receive system information and paging messages from the PLMN and initiate call setup for outgoing calls or other actions from the wireless terminal.

Initially, the wireless terminal looks for a cell which satisfies certain constraints (“suitable cell”) by checking cells in descending order of received signal strength. When camped on a cell, the wireless terminal regularly looks to see if there is a better cell for the wireless terminal based upon a cell re-selection criterion, and if there is, the better cell is selected. Also if one of the other criteria changes, (e.g., the current serving cell becomes barred), or there is a downlink signaling failure, a new cell is selected. This is called “cell reselection”.

The serving cell is the cell on which the wireless terminal is camped. Camped on a cell means the that the wireless terminal device has completed the cell selection/reselection process and has chosen a cell from which it plans to receive all available network services.

There are certain situations where a wireless operator wishes to lock the use of a wireless terminal to a certain specified cell area or areas. Thus, whenever there is a better cell (“cell A”), but not a cell permitted by operator, surrounding the current serving cell, the wireless terminal may choose and camp on “cell A”. However the choosing of “cell A” may cause the wireless terminal to not function at all. This is because the application management subsystem of the wireless terminal detects that “cell A” is not an operator-specified cell, thus causing the wireless terminal to enter a “limited service state”.

Another problem arises when the network output power changes, which may trigger cell reselection in a wireless terminal. The network output power adjustment may be employed for various reasons, for example, to optimize the uplink and downlink performance and minimize the effects of co-channel interference in the system. Under this situation, when the wireless terminal is placed in an overlapped coverage area of operator-permitted and non-permitted cells and the cell reselection process is triggered and performed, it chooses an operator-permitted cell as the serving cell, and the wireless terminal functions normally. However, a stronger but non-permitted cell is chosen as a new serving cell under the strategy of the conventional cell reselection, and the wireless terminal may not work and be put into a limited service state.

Where the network transmission power changes frequently, the wireless terminal would switch back-and-forth between the useable and unusable state. These occurrences can have a negative impact on a phone owner, as well as on those who want to get in touch with the phone user. It is therefore apparent that a need exists to develop a new cell selection and reselection procedure to address the operator's requirement of locking the wireless device use to certain specified cells.

### SUMMARY

The present invention provides a cell locking method capable of choosing the non-strongest, but operator-specified, cell for a wireless terminal to camp on. The wireless terminal synchronizes to and reads the information for the (as an example) 6 strongest non-serving carriers. Next, the wireless terminal checks each of the six cells in descending order of received signal level to determine whether this cell belongs to one of the operator- permitted cells. If not, the signal strength of this cell is set to zero. The checking process will continue until one operator-permitted cell is found and then this cell is marked as the serving cell. If the above mentioned attempt to find a valid serving cell fails, the terminal enters a no service state.

Use of the present method enables the wireless terminal successfully to camp on an operator specified cell, if certain other requirements are satisfied, e.g. this operator-specified cell is not “barred”. Otherwise, in case no such suitable cell is found, the wireless terminal enters a no service state. Thus, when a wireless terminal is placed or moving in a border area between operator-specified and non-specified cells and the non-specified cell is stronger than the specified one, the wireless terminal will still select the operator-specified cell. This ensures the normal functioning of the phone by avoiding interruption caused by frequent handover and other issues.

### BRIEF DESCRIPTION OF THE DRAWINGS

The foregoing aspects and many of the attendant advantages of the invention will become more readily appreciated as the same become better understood by reference to the following detailed description, when taken in conjunction with the accompanying drawings.

FIG. 1 is a flow chart illustrating a method for cell selection/reselection for the purpose of fixing the usage of a wireless device within certain cells according to one preferred embodiment of the invention.

### DESCRIPTION OF THE PREFERRED EMBODIMENT

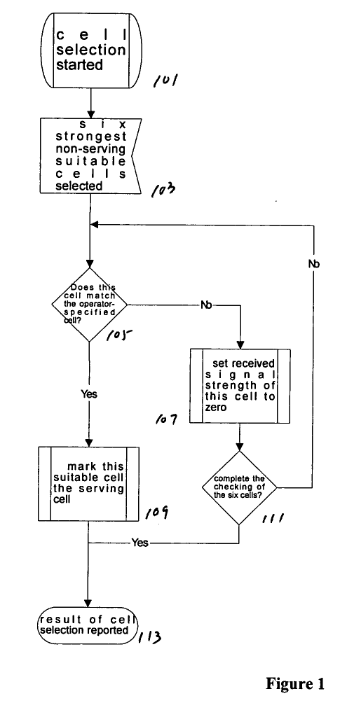

With reference to FIG. 1, a cell locking method described herein may be implemented in any wireless communication device, such as cellular phone.

As seen in FIG. 1, when a wireless device is turned on or enters a new service area, a cell selection process at box 101 begins. At box 103, the wireless device selects a maximum number of suitable cells. In this particular example it is six, but can be more or less. Indeed, in some situations, the wireless device may only detect a signal from less than six cells. The wireless device, for each detected cell, synchronizes to and reads the information for the cells.

Next, as described with boxes 105-111, the wireless device checks each of the six cells in descending order of received signal level (strength) to determine whether the cell belongs to one of the operator-permitted cells. Thus, at box 105, for each of the selected cells, a determination is made whether the cell is an operator-permitted cell. An operator-permitted cell is a cell that is designated in some manner by the service provided (operator) of the wireless device as an operator-permitted cell.

If at box 105 the cell is not an operator-permitted cell, then at box 107, the received signal strength indicator for that cell is set to zero, or some other disqualifying status. Next, at box 111, a determination is made as to whether all identified cells (from box 103) have been checked. If yes, then at box 113, the cell selection is complete and the designated cell is used. However, if not, then control returns to box 105 to allow for continued checking of the cell list.

Thus, the checking process will continue until either one operator-permitted cell is found, which the wireless terminal marks as the serving cell, or the completion of the checking of the last cell.

If at box 105 the cell is determined to be an operator-permitted cell, then at box 109, the wireless device designates the cell as the suitable cell for service. Because the cells in one embodiment are checked in descending order of signal strength, the process of FIG. 1 will result in the selection of the strongest signal from an operator-permitted cell. It can be appreciated that in other embodiments, the process may check all of the cell sites in any order. After all have been checked for operator-permitted status, then a selection of the strongest cell maybe made.

Thus, the method described herein for cell locking of a wireless device provides the advantage of completing the serving cell selection for a wireless device, even where the chosen serving cell is not the strongest one. Note importantly that if after the completion of the checking of all of the cells without finding a suitable cell, the wireless terminal enters a limited service state (for example no service).

While particular embodiments of the present invention have been described herein in detail, it is to be understood that various alterations, modifications and substitutions can be made therein without departing in any way from the spirit and scope of the present invention, as defined in the claim which follow. Various modifications and combinations of the illustrative embodiments, as well as other embodiments of the invention, will be apparent to persons skilled in the art upon reference to the description. It is therefore intended that the appended claim encompass any such modifications or embodiments.

What is claimed is:

1. A method for cell locking in a wireless device comprising:
(a) determining a predetermined number of cells that the wireless device receives a signal from;
(b) determining which of said predetermined number of cells is an operator-permitted cell; and
(c) determining from said operator-permitted cells of step (b) which has the strongest signal and having the wireless device lock onto that cell.

2. The method of claim 1 wherein if there are no operator-permitted cells detected, causing said wireless device to enter into a limited service state.

3. The method of claim 1 wherein said limited service state is a no service state.

4. A method for cell locking in a wireless device comprising:
(a) determining a predetermined number of cells that the wireless device receives a signal from;
(b) in descending order of signal strength of said predetermined number of cells, determining if said cell is an operator-permitted cell; and
(i) if not, marking said cell as disqualified and checking the next cell; and
(ii) if yes, marking said cell as the selected cell for said wireless device.

5. The method of claim 4 wherein if there are no operator-permitted cells detected, causing said wireless device to enter into a limited service state.

6. The method of claim 4 wherein said limited service state is a no service state.
